(19) United States
(12) Patent Application Publication
(10) Pub. No.: US 2011/0093321 A1
(43) Pub. Date: Apr. 21, 2011

(54) CARBON CREDIT EXCHANGE AND MARKETING SYSTEM

(76) Inventor: Foy Streetman, Chickasha, OK (US)

(21) Appl. No.: 12/974,618

(22) Filed: Dec. 21, 2010

Related U.S. Application Data
(63) Continuation-in-part of application No. 10/753,291, filed on Jan. 8, 2004, now abandoned.

(51) Int. Cl. G06Q 40/00; G06Q 30/00

(52) U.S. Cl. 705/14.16; 705/37

(57) ABSTRACT

A carbon exchange system includes a web-based server computer having hardware an operating system and a memory operably associated therewith and is operably connected to the Internet, and carbon credit exchange software (CCES) operably disposed on the memory and accessible through the operating system, wherein the CCES provides a domain for registering as a carbon sequestering tree provider wherein the carbon sequestering tree provider is required to enter data corresponding to geographic location for the carbon sequestering tree (geographic data “G”) and data corresponding to a number of trees (tree data “T”), where upon so doing the CCES manipulates the data to provide a “carbon sequestration average” (CSA) amount data corresponding to the entered data entered corresponding to a predetermined number of tons of oxygen (O₂) over predetermined period (P) and wherein the CSA amount data is employed by the CCES for trading purposes.

This is a continuation in part of U.S. Ser. No. 10/753,291 filed Jan. 7, 2004.

### BACKGROUND OF THE INVENTION

### Field of Invention

This invention relates to a carbon credit application. More particularly, the invention relates to a method of marketing employing carbon credits and one which in part employs a web-based system.

The Kyoto Protocol, the Clean Development Mechanism and Joint Implementation resulted from international political response to climate change and began with the United Nations Framework Convention on Climate Change (UNFCCC) adopted in 1992. UNFCCC proposed a framework for action aimed at stabilizing atmospheric concentrations of greenhouse gases (GHG) to prevent dangerous human interference with the climate system.

The Kyoto Protocol to the Convention was adopted in 1997 by more than 170 countries significantly strengthened the UNFCCC by committing many industrialized countries and economies in transition, the so-called ‘Annex 1 countries’, to individual, legally-binding targets to limit or reduce their overall emissions of greenhouse gases by at least 5% below the 1990 levels of emission during the period 2008-2012.

The Protocol allows for several “flexible mechanisms” such as emissions trading, the clean development mechanism (CDM) and joint implementation to allow Annex I countries to meet their GHG emission limitations by purchasing GHG emission reductions credits from elsewhere, through financial exchanges, projects that reduce emissions in non-Annex I countries, from other Annex I countries, or from annex I countries with excess allowances.

Each Annex I country is required to submit an annual report of inventories of all anthropogenic greenhouse gas emissions from sources and removals from sinks under UNFCCC and the Kyoto Protocol. These countries nominate a person (called a “designated national authority”) to create and manage its greenhouse gas inventory. Virtually all of the non-Annex I countries have also established a designated national authority to manage its Kyoto obligations, specifically the “CDM process” that determines which GHG projects they wish to propose for accreditation by the CDM Executive Board.

While emission reductions generated by these three flexible mechanisms have different technical names dependent on which mechanism they arise from, they are collectively referred to as “carbon credits.” Carbon credits are measured in tons of carbon dioxide equivalent (tCO2e). One carbon credit represents one ton of CO2e non-emitted or reduced. The flexible mechanisms, along with the European Union Emissions Trading Scheme (EU ETS) put in place by the European Union to meet its Kyoto target, created the largest environmental market in the world for the trading of these carbon credits.

Industrial nations are challenged to find ways to cut heat trapping emissions from burning fossils fuels which are believed to have an adverse affect on our environment. Carbon reducing plants provide aid in this regard.

Photosynthetic organisms comprise a mechanism for cleansing or removing greenhouse gases from the atmosphere. Using light energy from the sun, carbon in the form of carbon dioxide can be removed by plant growth which is a natural process which produces organic matter by removing carbon compounds from the atmosphere.

The amount of carbon sequestered in some woody plants is difficult to accurately measure in the living plant without destroying the plant. Trees in tropical and boreal forests have branches and limbs of varying lengths, diameters and are irregularly spaced and shaped. Woody plants sequester a large part of their carbon above ground. Grassy & herbaceous plants reach physiological maturity much sooner than woody plants and therefore can begin to sequester maximum amounts of carbon. In as little as sixty days from germination, annual grassy and herbaceous plants are sequestering maximum amounts of CO₂. This carbon sequestration is subject to limiting factors from intentional or unintentional fire, disease, decay, storms and insects. One fact remains despite these known limiting factors, forests and grassy and herbaceous plants absorb million tons of carbon each year, and if properly maintained, can counterbalance carbon based emissions. To be Kyoto Protocol compliant with Clean Development Mechanism (CDM) carbon offset, a Certified Emission Reduction (CER) is a carbon offset certificate which is issued every time a Kyoto Protocol member state reduces or removes one ton of CO2 (equivalent) through carbon projects registered with the CDM.

While the theory of using carbon credits and a carbon exchange is a potential solution, there lacks a suitable way to implement and market such credits with a worldwide acceptance. Therefore, the instant invention provides a solution to viably implement such an exchange carbon credit system and promote green plant growth and reforestation.

### SUMMARY OF THE INVENTION

It is an object to facilitate exchange of carbon credits through carbon sequestration averaging.

It is another object to provide a system for exchange of carbon credits.

It is an object to provide a method of marketing products which has a beneficial effect of reforestation.

It is an object to provide a web-based marketing system for products and services with a biproduct of generating a carbon credit logging system.

It is another object to reduce carbon emissions in the environment.

It is further another object of the invention to provide a method for facilitating carbon sequestration.

A further object is to provide a novel marketing system for carbon sequestration.

Accordingly, the invention in one embodiment includes a web-based server computer having hardware an operating system and a memory operably associated therewith and is operably connected to the Internet. Further, carbon credit exchange software (CCES) is operably disposed on the memory and accessible through the operating system, wherein the CCES provides a domain for registering as a carbon sequestering tree provider wherein the carbon sequestering tree provider is required to enter data corresponding to geographic location for the carbon sequestering tree (geographic data “G”) and data corresponding to a number of trees and optionally a carbon sequestering tree type planted (tree data “T”), where upon CCES manipulates the data to provide a “carbon sequestration average” (CSA) amount data corresponding to the particular entered data entered which corresponds to a predetermined number of tons of oxygen (O₂) over predetermined period (P) and the wherein the CSA amount data can be used for trading purposes.

Additionally, the invention provides for an exchange wherein a the carbon credits CC can be functionally determined and quantified through the CCES and banked as a tradable commodity. Buyer's of the commodity can register through the CCES and obtain a carbon credit bank account (BA).

A referral system is provided wherein a referring party R can obtain a carbon credit (or portion thereof) as a result of a buyer B purchase or trade carbon credits CC through the exchange. These credits or debits are reflected buyer's account BA. In a preferred embodiment, the display can be selectively publicly displayed through the exchange and provide a visual indicator of an entity's carbon footprint. For example, it can be that based upon an entity's carbon footprint, their account changes color from grey to green as it becomes filled with more carbon credits.

In a unique aspect of the invention, there is provided a marketing affiliate system wherein a media hotlink can be provided as an attachment to one's e-mail signature thereby sharing an opportunity with your family, friends, and associates. The hotlink can include an attractive “icon” which is incorporated into part of one's electronic signature for each email sent. Additionally, the system of the invention provides a Carbon Neutrality banner which can be used on one's website, Face book, Twitter and or Blogs. Both the Icon and the Banner are hotlinks which when clicked will come directly to such party's Carbon Credits Bank account showing a viewer what such party is doing. In so doing, such view is provided through the exchange system of the instant invention information and opportunity to register as part of the affiliate system.

Additionally, another way for earning carbon credits can include that a product or service (PS) purchased by Buyer B carries a predetermined number of trees to be planted (or carbon credits earned) and provides an add-on value of a value in excess of the purchase amount for a good and a service. A record of such transaction is electronically recorded in the database and is rendered to public review.

The carbon credit exchange software associates a number of carbon credits with the consumer based upon the number of trees planted for the particular geographic area. A carbon credit calculator is provided to enable the consumer to determine the amount of greenhouse gases produced/consumed each year based on the good and/or service.

The carbon credit exchange software enables creation of a client account in the memory and enables maintaining carbon credit balance in the account and enables access of multiple clients, each client having a carbon credit account. The carbon credit exchange software provides for securely creating and accessing the client account. The carbon credit exchange software enables a client accessing the carbon credit exchange software to trade, purchase or sell a carbon credit.

The present invention is believed to present a vehicle to successfully implement a carbon exchange as well as a marketing process by which all consumers will be able to purchase products or services which provide for reforestation and gain an add-on value which includes a product or service and a carbon credit consumer symbol (“CCCP”) value through the system of the instant invention.

Other objects and advantages will be apparent upon reading the description and viewing the drawings hereinafter.

### BRIEF DESCRIPTION OF THE DRAWING

In the detailed description which follows, reference is to be made to the drawing comprised of the following figures:

FIG. 1 is a schematic of the invention.

FIG. 2 depicts a carbon Footprint.

FIG. 3 depicts a carbon calculator.

FIG. 4 depicts a carbon credit symbol through the instant invention.

FIG. 5 depicts an aspect of marketing using the symbol in FIG. 4.

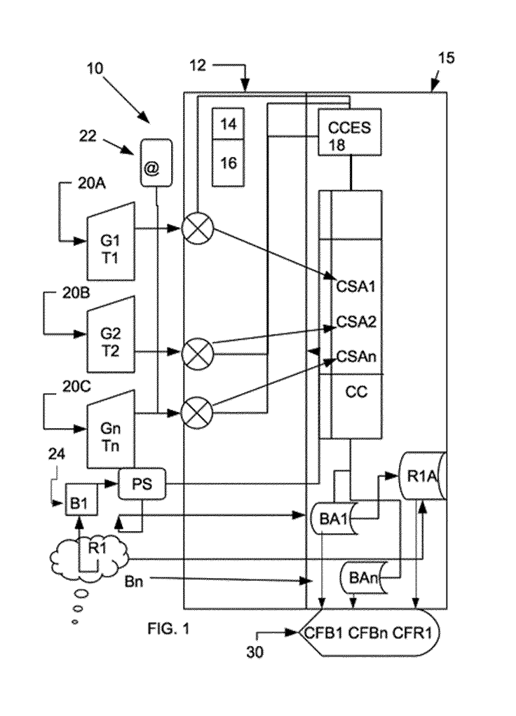

### DETAILED DESCRIPTION OF THE PREFERRED EMBODIMENTS

A carbon credit exchange and marketing system of the instant invention promotes reforestation and enables acceptance of a carbon credit system and is generally referred to by the numeral 10. The system 10 of the invention employs a computer based device, such as a web-based server computer 12 operably connected to an Internet 22 and has an operating system 14 and a memory 16 operably associated therewith. Carbon Credit Exchange Software 18 is operably disposed in the memory 15 (which can be separate or part of memory 16) and accessible through the operating system 14 and is equipped to display a web site portal though which transactions can take place.

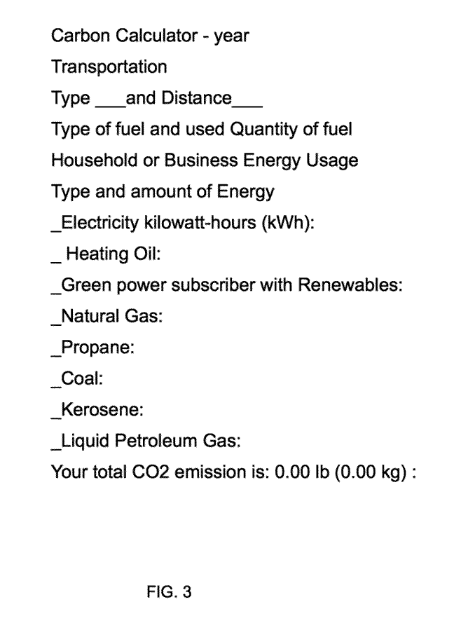

The CCES 18 provides a domain for registering as a carbon sequestering tree provider 20A, 20B, 20C wherein the carbon sequestering tree provider 20A, 20B, 20C is required to enter data corresponding to geographic location for the carbon sequestering tree (geographic data “G1, G2, . . . Gn”) and data corresponding to a number of trees and optionally a carbon sequestering tree type planted (tree data “T1, T2, . . . Tn”), where upon so doing there is generated a predetermined number of tons of oxygen (O2) over predetermined period (P). The CCES 18 manipulates the data to provide a “carbon sequestration average” (CSA1, CSA2, . . . CSAn) amount data corresponding to the particular entered data entered wherein the CSA1, CSA2, . . . CSAn amount data can be used for trading purposes. The CCES 18 associates a number of carbon credits with the number of trees planted for the particular geographic area. An exemplary carbon credit calculator is provided in FIG. 3 to enable the consumer to determine the amount of greenhouse gases produced/consumed each year based on the good and/or service.

The formula can be represented as follows:

CSA=(number of trees)*T(tree type)*G(Geogaphic location of trees),

where T is a factor based upon tree type and G is a factor based upon geographic region.

Additionally, the invention provides for an exchange wherein a the carbon credits CC can be functionally determined and quantified through the CCES 18 and banked as a tradable commodity. Buyer's B1 . . . Bn of the commodity can preferably be registered via a register through the CCES 18 and obtain an account BA1 . . . BAn where carbon credit balances are maintained.

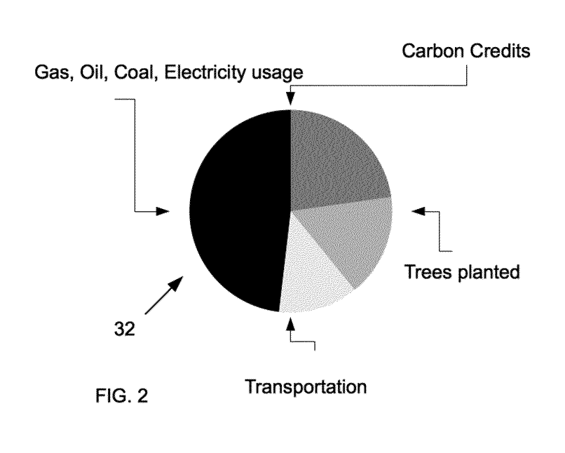

A referral system is also enabled through the instant invention wherein a referring party R1 can likewise obtain an account R1A (which can likewise be a carbon credit bank account) and obtain a carbon credit (or portion thereof) as a result of a buyer B1 . . . Bn purchase or trade carbon credits CC through the exchange system 10. These credits or debits are reflected buyer's account BA1 . . . BAn and R1A. In a preferred embodiment, the CCES 18 through the portal 30 can enable a selective public display through the exchange system 10 and provide a visual indicator 32 of an entity's carbon footprint. The carbon footprint shown is a function of a party's account which in the given example changes color from black to grey to green as it becomes filled with more carbon credits. This can be seen in FIG. 2.

The CCES 18 enables creation of a client account (be it provider, buyer or referral party) in the memory and enables maintaining carbon credit balance in the account and enables access of multiple clients, each client having a carbon credit account. The CCES 18 provides for securely creating and accessing the client account. The CCES 18 enables a client accessing the carbon credit exchange software to trade, purchase or sell a carbon credit. The clients can include buyers B1-Bn and sellers (providers 20A-20C) who themselves can also be buyers. An example of implementation of the invention is as follows:

Buyer B1 buys a predetermined number of trees X1, then referring party R1 receives a predetermined number Y1 of carbon credit(s); if B1 refers B2 who buys X1 trees, then B1 receives Y1 carbon credits and R1 receives (Y1)/2 carbon credits, and then on the next down line then Bn receives Y1 carbon credits B2 receives (Y1)/2 carbon credits, R1 receives (Y1)/4 carbon credits and so on such that the referral chain will stop when R1 receives (Y1)/8 carbon credits.

One's bank account BA can be visually represented with via color changing tree, for example, which will show a particular shade of green, e.g., as light to dark green trees, as a function of how many of these units you own. Alternatively, the bank account BA can be represented with a series of boxes, the first can be light green and represents a number of trees (or carbon credits) you planted or earn as an affiliate, the second can be dark green and represents the total number of trees (or carbon credits) you have sold as emissions reductions units to another party, and the third can be blue which represents emission reductions units held at any given time and available on the exchange.

For example, one may post the number of carbon credits held and offer to sell these through the exchange system 10 to industrial buyers (who may be a large consumer such as a corporate entity) who needs or wants the units to meet its social responsibility to the environment. Once sold, the CCES 18 will credit/debit the respective account e.g., RA1, BA1, with the value/funds of the transaction.

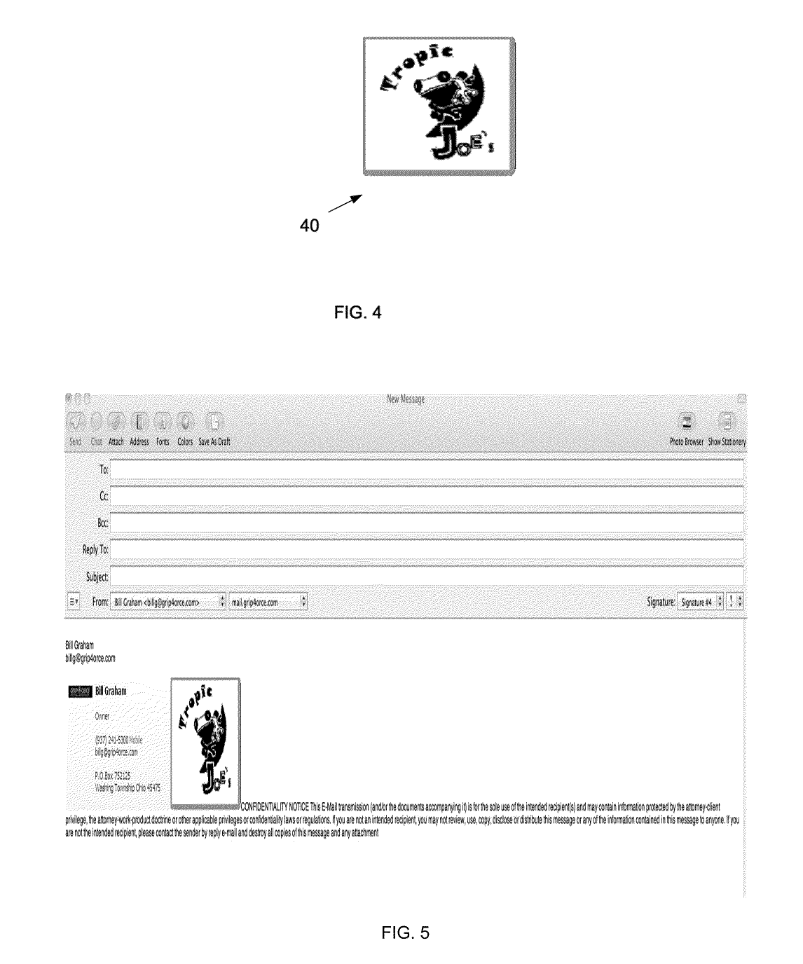

In a unique aspect of the invention, once a party, either Buyer B or referring party R, for example, becomes registered with the exchange system 10 through CCES 18, the CCES 18 provides a unique marketing affiliate system wherein a media hotlink (e.g., an attractive “icon”) such as the icon seen in FIG. 4 can be provided to such party. This hotlink icon is incorporated as part of such party's e-mail signature and is uniquely linked to such party's account BA1 or RA1, for example, in a way such that when clicked it redirects a view to a public view showing such party's contribution to carbon sequestration via display portal 30 for example. This enables sharing an opportunity with your family, friends, and associates what one is doing to support the environment. Additionally, the CCES 18 of the invention provides a Carbon Neutrality banner (which can include icon in FIG. 4) to such party which can be used on one's website, Face book, Twitter and or Blogs. Both the Icon and the Banner are hotlinks which when clicked will come directly to such party's Carbon Credits Bank account showing a viewer what such party is doing. In so doing, such view is provided through the exchange system of the instant invention information and opportunity to register as part of the affiliate system.

Additionally, another way for earning carbon credits can include that a product or service (PS) which is registered with the CCES 18 and purchased by Buyer B wherein it carries a predetermined number of trees to be planted (or carbon credits earned) and provides an add-on value of a value in excess of the purchase amount for a good and a service. A record of such transaction is electronically recorded in the database and amount of carbon credit(s) credited to the respective buyer's account, e.g., BA1.

The marketing system 10 provides for a buyer B via a computer 24, for example, to select a particular good pay for desired product or good wherein a predetermined number of trees are planted based upon a purchase amount, wherein upon purchasing such product a consumer receives trees planted (via provider 20A, for example) or carbon credits on the buyers's behalf and wherein a record of such purchases and trees planted are electronically recorded in database of a memory 15 and which is selectively rendered to public review. Further, as a result of such acquisition, the buyer B1 is provided an added value coupon for a good or service in excess of the amount spent by the consumer. The CCES 18 enables associating a number of carbon credits and carries a predetermined number of carbon credits.

The CCES 18 provides a portal web site which can be used to sell a product or a service wherein through the purchase there are a predetermined number of trees planted on the consumer's behalf and wherein a predetermined number of carbon credits are assigned toward the consumer's benefit as a result of the planting of such trees.

A “feel good” item in the form of a product or service can be sold carrying with it a predetermined carbon credit value exemplified with Carbon Credit (CC) value and can be provided with the CCCP symbol evidencing such transaction, for example, which is related to the planting of a tree, for example. The feel good product which the purchaser receives can be, for example, a T-shirt with a particular logo carrying a tag or mark identifying a carbon credit consumer symbol (“CCCP”), in FIG. 4 shown to be “Tropic Joe's symbol with a tree frog”, indicating that a number of CC's (i.e., a predetermined number of carbon credit(s) based upon a standard which is predetermined) have been purchased. The carbon credit(s) can then be used by the purchaser towards other purchases or required carbon credit uses. Similarly, a Rainforest credit sponsorship service can be purchased through the carbon credit exchange software 18 of the invention, e.g., sponsoring a youth group to take a trip to aid in natural reforestation, which is another aspect of the invention.

By natural reforestation, the instant invention predetermines that a given tree has a certain period of its initial growth and life span in which provides maximum carbon absorption. For example, the first ten years of its life, after which its carbon absorption utility diminishes. The present invention provides an exchange system wherein the CCCP symbol is only used in association with goods and services which subscribe to the attachment and assignment of carbon credits through natural reforestation. Natural reforestation would provide that these carbon absorption resources be periodically changed out to provide the maximum benefit to the environment as well as the economy. For example, the initially planted trees can be harvested after a period of maximum carbon absorption life and at point where the harvested tree can also provide a useful source of raw material to the economy.

The purchaser receives a feel good item via the system 10 which is founded with a verifiable mechanism (carbon sequestration averaging) with the CCCP symbol to show its sponsorship as well as gain carbon credits to the buyer's account BAn. The purchase of these CCCP good or service indicates that the purchaser initiated a carbon reduction process through natural reforestation as a result of the purchase the good/service. Each good and service provided by through or associated with a common CCCP issuing source, which can be a foundation or entity promoting reforestation, carries with it media bearing the CCCP symbol and a predetermined carbon credit value. The CCCP symbol is predetermined by the common source as is the carbon credit value for each good/service.

The purchased CCCP goods or services, in turn, carbon credits, can be used to sequester greenhouse gases, for example, an inventory of a geographic area capable of such sequestration, e.g., hectors of land, can be used for planting trees by the foundation. To understand the functionality of how the CCCP purchase can be effective, one needs to understand the effect of each product/service on emission. Assuming a good/service emits X lbs. of CO₂ per unit used; Y number of carbon credits can be calculated based on known output of a particular forestation or grassy/herbaceous land hector at a given dollar value Z $/lb.

Consequently, a formula can be derived:

$$\frac{( X good \text{/} service requires lbs cc ’ s \text{/} unit )}{( Z land type size yields number lbs cc ’ s \text{/} \$ )} = Y carbon credits @ \$ \text{/} unit cost .$$

A cost value can be created with respect to the given good/service and assessed to the same. Thus, it can be learned that each product/service can bear a carbon credit value. The instant invention, aids in promoting a self help toward cleaning up the environment while getting some tangible and intangible value from the same.

The carbon credit exchange software 18 preferably includes exemplary carbon calculator as represented in FIG. 3 for determining a number of carbon credits for each particular predetermined good or service. Preferably, the product or service can include a predetermined carbon credit value for use in the system 10 and provides a media, which can be a tag, displayed image, associated sheet or other media, carry a CCCP symbol. It is understood that the carbon credit producer can be one of the type of carbon reducing systems previously described, i.e., planting of trees, grass, herbaceous plants, etc. good or service which recycles carbon emissions, whereas the carbon credit user can be a good or service which through manufacture or use creates an emission of the type including CO₂ or other carbon based harmful emission.

The carbon credit exchange software 18 enables creation of a client account in the memory 15 for maintaining carbon credits in the account. The carbon credit exchange software 18 enables a client accessing the carbon credit exchange software 18 to purchase or sell a carbon credit or to list one of an offer to sell a carbon credit producer or carbon credit user. Additionally, the carbon credit exchange software 18 initiates a carbon reduction/recycling process as a result of the purchase, e.g., the planting of a tree. The purchase also causes a product or service item bearing the CCCP symbol to be sent to the purchaser, e.g., a T-shirt bearing the CCCP symbol.

Further, products or services bearing the CCCP symbol which are sold in the economy external to the system 10 can be registered in database on the memory 15 via the carbon credit exchange software 18 using a product or service code, e.g., a serial number. Upon purchase of such CCCP bearing item, a consumer can access the web site and the client's account and using the carbon credit exchange software 18 and enter the code of the product/service and be credited a number of carbon credits to his/her account. These credits can be subsequently used for any variety of purchase or trading transactions.

An example of how this works is as follows. A consumer has the option to purchase one of two cellular telephones. One phone has the CCCP stamp indicating the manufacturer has purchased carbon credits covering any environmental damage that may have been caused in the production of their cell phone. The consumer equates that to being environmentally responsible and elects to purchase the cell phone with the “green CCCP” label. Let's say the phone has 10 CCCP points. The consumer can then log onto the system 10 and via the web site enter the code provided on the cell phone, be credited the carbon credits and use these credits to purchase various other items which exist available at the web site, for example, in similar way one might use mileage points to get a discount on an airline ticket.

The carbon credit exchange software 18 enables access of multiple clients, each client has a carbon credit account. The carbon credit exchange software 18 enables a trade of carbon credits between the clients. The carbon credit exchange software 18 provides for securely creating and accessing the client account, i.e., a login page is provided for the user.

The system 10 automatically converts X number of trees planted to absorbed carbon and released oxygen, and displays under the user's handle or name (at their discretion). In addition, carbon/oxygen credits are paid to the referring affiliates so they benefit from all sales they refer through the exchange system 10. A tree type T planted in Domain D (tropic) will release 2.185 tons of Oxygen over years Y 20 years while capturing 0.82 tons of carbon. As donors plant trees the system 10 employing “carbon sequestration averaging” (CSA) provides for determining carbon credit value for a particular geographic system and tree type.

The above described embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

What is claimed is:

1. A carbon exchange system, which includes:
a web-based server computer having hardware an operating system and a memory operably associated therewith and is operably connected to the Internet; and
carbon credit exchange software (CCES) operably disposed on the memory and accessible through said operating system, wherein said CCES provides a domain for registering as a carbon sequestering tree provider wherein said carbon sequestering tree provider is required to enter data corresponding to geographic location for the carbon sequestering tree (geographic data) and data corresponding to a number of trees (tree data), where upon so doing said CCES manipulates said data to provide a “carbon sequestration average” (CSA) amount data corresponding to said entered data entered corresponding to a predetermined number of tons of oxygen (O₂) over predetermined period (P) and wherein said CSA amount data is employed by said CCES for trading purposes.

2. The carbon exchange system of claim 1, wherein said tree data includes a carbon sequestering tree type for each tree.

3. The carbon exchange system of claim 1, wherein said CCES transforms said CSA amount into carbon credits.

4. The carbon exchange system of claim 3, wherein said CCES enables a user to register as a registered user of said exchange and obtain an account for one of purchasing, selling and exchanging of carbon credits.

5. The carbon exchange system of claim 1, which further provides a referral system wherein a referring party obtains at least a portion of a carbon credit as a result of a buyer purchasing or trading carbon credits through said exchange as a result of a referral which is tracked through said CCES.

6. The carbon exchange system of claim 4, wherein credits and debits are reflected in said account.

7. The carbon exchange system of claim 4, wherein said CCES selectively displays for public viewing a visual indicator of said registered user carbon footprint as a function of transactions through said registered user's account.

8. The carbon exchange system of claim 7, wherein said visual indicator of said registered user's carbon footprint includes a display of said registered user's account changes color from non-green to darker shades of green as it becomes increasingly filled with carbon credits.

9. The carbon exchange system of claim 1, which further provides a marketing affiliate system wherein a media hotlink is provided by said CCES for attachment to an e-mail signature of said registered thereby showing said registered user involvement with said exchange, whereby an e-mail recipient can click on said hotlink and be redirected to said exchange where said recipient can view registered user's carbon footprint.

10. The carbon exchange system of claim 1, which further provides a marketing affiliate system wherein a media hotlink is provided by said CCES and resides on a web-site of said registered user thereby showing said registered user involvement with said exchange, whereby an e-mail recipient can click on said hotlink and be redirected to said exchange where said recipient can view registered user's carbon footprint.

11. The carbon exchange system of claim 1, wherein said CCES provides for registering products and or services which upon purchase thereof carry at least a portion of a carbon credit value which is credited to said registered user's account.

12. The carbon exchange system of claim 1, wherein said CCES provides for securely creating and accessing said registered user's account.

13. A carbon exchange marketing system, which includes:
a web-based server computer having hardware an operating system and a memory operably associated therewith and is operably connected to the Internet; and
carbon credit exchange software (CCES) operably disposed on the memory and accessible through said operating system, wherein said CCES provides a domain for enabling a user to register as a registered user of said exchange and obtain an account for one of purchasing, selling and exchanging of carbon credits and generate a carbon footprint as a function of said carbon credits in said account, said CCES providing a media hotlink for said registered thereby showing said registered user involvement with said exchange marketing system, whereby a viewer said hotlink of said registered user can click on said hotlink and be redirected to said exchange where said recipient can view registered user's carbon footprint.

14. The carbon exchange marketing system of claim 13, wherein said CCES provides said media hotlink for attachment to an e-mail signature of said registered user.

15. The carbon exchange marketing system of claim 13, wherein said CCES provides said media hotlink as a banner for a web site of said registered user.

16. The carbon exchange marketing system of claim 13, wherein said CCES enables a carbon sequestering tree provider to register and obtain an account wherein said carbon sequestering tree provider is required to enter data corresponding to geographic location for the carbon sequestering tree (geographic data “G”) and data corresponding to a number of trees (tree data “T”), where upon so doing said CCES manipulates said data to provide a “carbon sequestration average” (CSA) amount data corresponding to said entered data entered corresponding to a predetermined number of tons of oxygen (O₂) over predetermined period (P) and wherein said CSA amount data is employed by said CCES for trading purposes.

17. The carbon exchange system of claim 16, wherein said tree data includes a carbon sequestering tree type for each tree.

18. The carbon exchange system of claim 13, wherein said CCES selectively displays for public viewing a visual indicator of said registered user carbon footprint as a function of transactions through said registered user's account.

19. The carbon exchange system of claim 13, wherein said visual indicator of said registered user's carbon footprint includes a display of said registered user's account changes color from non-green to darker shades of green as it becomes increasingly filled with carbon credits.

20. The carbon exchange system of claim 13, wherein said CCES provides for securely creating and accessing said registered user's account.
